(19) United States
(12) Patent Application Publication
(10) Pub. No.: US 2011/0005979 A1
(43) Pub. Date: Jan. 13, 2011

(54) PROCESSING WASTE

(75) Inventors: JAN BENJAMINS, ELIM (NL); ALEX ZWIERS, HOOGEVEEN (NL)

Correspondence Address: Pearne & Gordon LLP, 1801 East 9th Street, Suite 1200, Cleveland, OH, 44114-3108, US

(73) Assignee: LUBO SCREENING- & RECYCLINGSYSTEMS B.V., AW EMMEN (NL)

(21) Appl. No.: 12/831,719

(22) Filed: Jul. 7, 2010

Related U.S. Application Data
(60) Provisional application No. 61/224,522, filed on Jul. 10, 2009.

(30) Foreign Application Priority Data
Jul. 9, 2009 (EP) 09165090.3

(51) Int. Cl. B07B 1/00; B07B 1/46

(52) U.S. Cl. 209/235; 209/240

(57) ABSTRACT

A waste processing apparatus for separating a target material from other materials lighter than the target material and dust, and for classifying the target material into one or more fractions, comprising a housing having an opening for the input of waste, a first end and a second end; a first sieve screen positioned under the opening and extending between the first and second ends; a first channel, underneath the first sieve screen, for conveying a first air stream from a first channel inlet at the first end of the housing to a first channel outlet at the second end of the housing, the first air stream serving to entrain lighter materials and dust which have passed through the first sieve screen and transporting them to the first channel outlet; a vibrator operable to urge target material that has passed through the first sieve screen towards a first target material outlet at the first end of the housing; wherein the apparatus further comprises a barrier, located between the first sieve screen and the first air stream, comprising a plurality of spaced slats, each slat pointing downwardly in a direction having a component parallel to the first air stream which is in the direction of the first air stream.

The present invention relates generally to processing waste. The present invention has particular, but not exclusive, application to situations in which it is desired to extract a target material suitable for recycling from co-mingled waste.

EP774302 shows a prior art system concerned with separating a material which comprises solid particles of different shape, size and/or density into at least two fractions. In this system, material is dropped through a row of slats oriented obliquely to a sieve screen. However, in this system, an air stream is arranged to flow upwardly between the slats such that lighter particles do not fall through the sieve screen.

With this is mind, according to a first aspect, the present invention may provide a waste processing apparatus for separating a target material from other materials lighter than the target material and dust, and for classifying the target material into one or more fractions, comprising:

a housing having an opening for the input of waste, a first end and a second end;
a first sieve screen positioned under the opening and extending between the first and second ends;
a first channel, underneath the first sieve screen, for conveying a first air stream from a first channel inlet at the first end of the housing to a first channel outlet at the second end of the housing, the first air stream serving to entrain lighter materials and dust which have passed through the first sieve screen and transporting them to the first channel outlet;
a vibrator operable to urge target material that has passed through the first sieve screen towards a first target material outlet at the first end of the housing;
wherein the apparatus further comprises a barrier, located between the first sieve screen and the first air stream, comprising a plurality of spaced slats, each slat pointing downwardly in a direction having a component parallel to the first air stream which is in the direction of the first air stream.

As material passes through the first sieve screen and the barrier and impinges on the first air stream, the effect of disruption to the first air stream is kept local with the barrier serving to prevent or at least reduce the blow back of lighter material and dust towards the first sieve screen.

Preferably, the spacing between each slat is set such that material that has passed through the first sieve screen is just able to pass through the barrier. In other embodiments the spacing between the slats can be made appreciably larger.

Preferably, the tips of each slat occupy the same plane.

In a preferred embodiment, the apparatus preferably comprises a second sieve screen, having a finer mesh than the first sieve screen, positioned below the first channel to enable two fractions of the target material to be classified. In such an embodiment, the apparatus comprises a second channel, underneath the second sieve screen, for conveying a second air stream from a second channel inlet at the first end of the housing to a second channel outlet at the second end of the housing, the second air stream serving to entrain lighter materials and dust which have passed through the second sieve screen and transporting them to the second channel outlet, wherein the vibrator is further operable to urge target material that has passed through the second sieve towards a second target material outlet at the first end of the housing.

Other aspects and preferred features of the present invention are described in the following description and defined in the appended claims.

Exemplary embodiments of the invention are hereinafter described with reference to the accompanying drawings, in which:

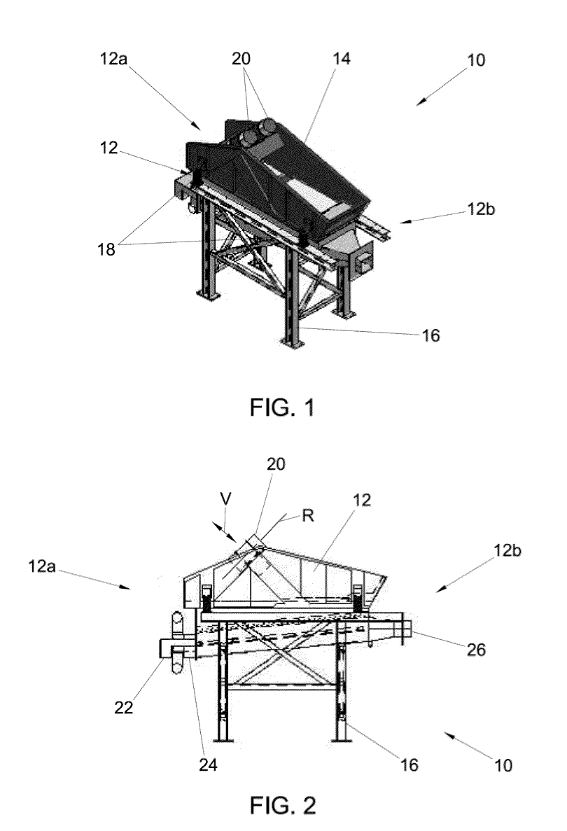

FIG. 1 shows a perspective view of a screener in accordance with the present invention;

FIG. 2 shows a central longitudinal, cross-sectional view of FIG. 1 illustrating the vibrating motion of the screener in use;

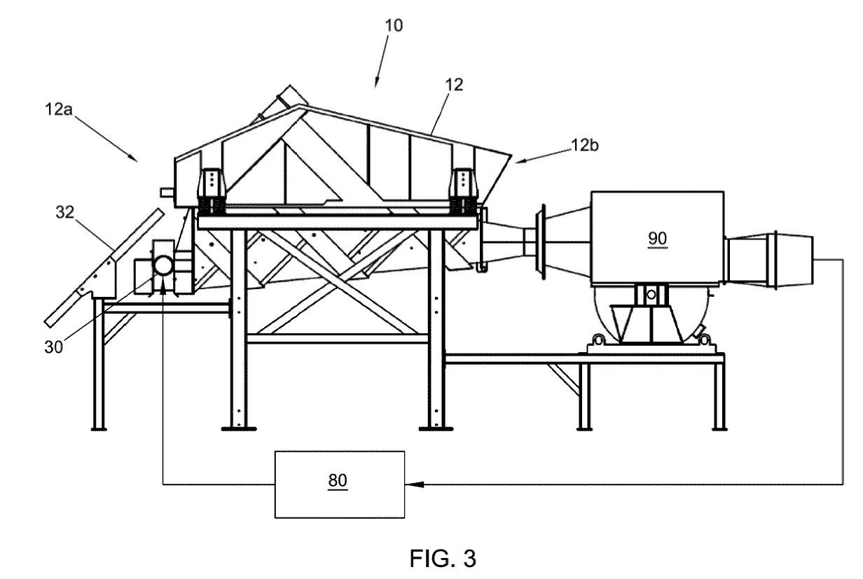

FIG. 3 shows a side view of the screener of FIG. 2 deployed as part of a waste processing system;

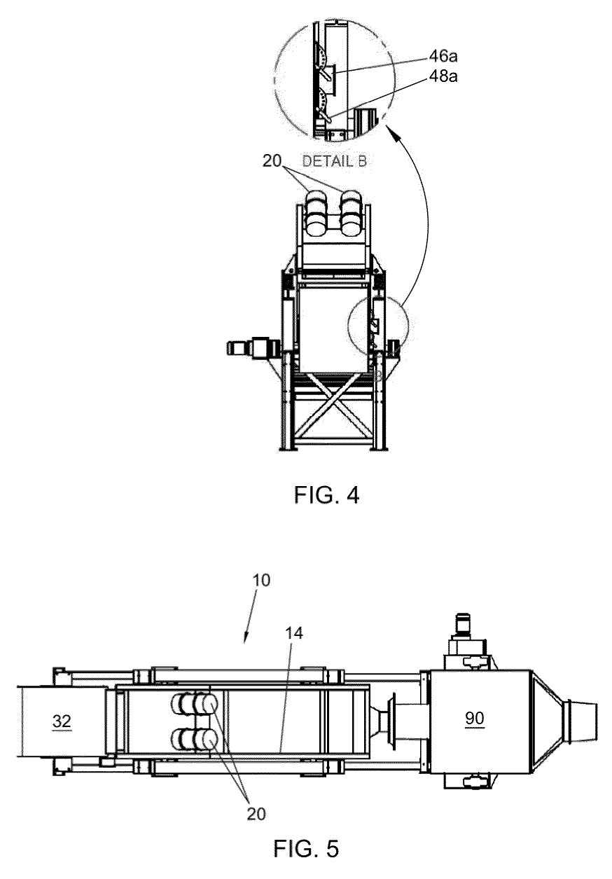

FIG. 4 shows a view of parts of the FIG. 3 system when viewed from the left-hand side;

FIG. 5 shows a view of FIG. 4 when viewed from above; and

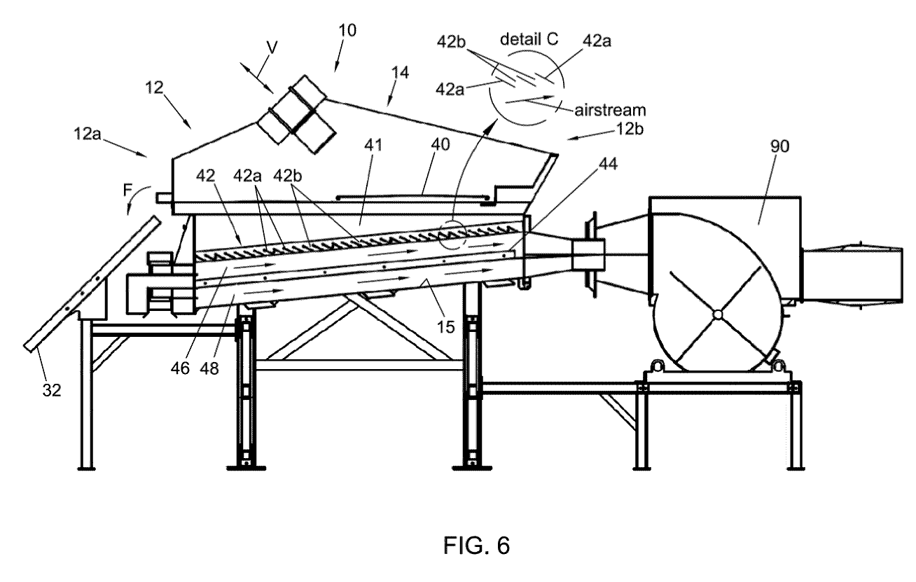

FIG. 6 shows a central longitudinal, cross-sectional view of FIG. 4.

A waste processing apparatus for classifying co-mingled waste into a coarse and a fine fraction of granular glass waste and simultaneously separating those fractions from other unwanted waste material including other waste materials lighter than glass and dust is shown in FIG. 1 and is referred to as a screener 10. The screener 10 comprises an elongate housing 12 having first and second opposite ends 12a, 12b, respectively, an upwardly-facing opening 14 via which co-mingled waste may be dropped into the screener 10 and a housing floor 15 (visible in FIG. 2). The housing 12 is mounted on a supporting framework 16 via oscillating isolators 18.

Referring to FIG. 2, the screener 10 further comprises two contra-rotating vibratory motors 20 which are mounted to the housing 12 with an axis of rotation indicated by the axis R so as to cause the housing 12, when the motors 20 are driven, to vibrate back and forth in a direction indicated by arrow V. The oscillating isolators 18 serve to reduce the amount of vibration which is transmitted to neighbouring structures. As is described in more detail below, the screener 10 delivers a coarse fraction of cleaned glass to a coarse glass outlet 22, a fine fraction of cleaned glass to a fine glass outlet 24 and unwanted waste material including other waste materials lighter than glass and dust to an unwanted material outlet 26.

FIG. 3 shows the screener 10 deployed in a waste processing system. In addition to the screener 10, the system comprises a fan 80 which supplies an air stream to an air stream inlet 30 of the screener 10 and a cyclonic material separator 90 which is coupled to the unwanted material outlet 26 of the screener 10. The material separator also includes a connection to the suction side of the fan 80. As shown in FIGS. 3 and 5, the screener 10 further comprises a chute 32 disposed adjacent the first end 12a of the housing 12.

The internal structure of the screener 10 is shown in FIG. 6. A first, upper coarse sieve screen 40 is positioned below the opening 14 to receive the co-mingled waste.

The sieve screen 40 has a mesh size of 30×22 mm. A barrier 42 extending substantially from the first end 12a to the second end 12b of the housing 12 is disposed below and spaced from the sieve screen 40. The region between the sieve screen 40 and the barrier 42 is designated 41.

The barrier 42 is slightly inclined with respect to the horizontal with the end of the barrier 42 adjacent the first end 12a of the housing 12 being slightly lower than its other end. The barrier 42 comprises a row of spaced slats 42a, each slat 42 pointing downwardly in a direction towards the second end 12b of the housing 12. The passages 42b defined between the slats 42a are, at minimum, of sufficient size to also allow waste that has passed through the sieve screen 40, but could be somewhat larger. A second, lower fine sieve screen 44 is disposed at a position partway between the barrier 42 and the housing floor 15. The sieve screen 44 has a mesh size of 10×10 mm. The sieve screen 44 extends substantially from the first end 12a to the second end 12b of the housing 12 and is angled so as to have a slight incline with respect to the horizontal in a similar manner to the barrier 42. It will be noted from FIG. 6 that the housing floor 15 is also similarly inclined.

The region between the barrier 42 and the sieve screen 44 defines an upper channel 46 from the air stream inlet 30 to the unwanted material outlet 26 along which an air stream may flow. Similarly, the region between the sieve screen 44 and the housing floor 15 defines a lower channel 48 from the air stream outlet 30 to the unwanted material outlet 26 along which an air stream may flow. FIG. 4 shows, in detail B, adjustors 46a, 48a which control the pressure of the air streams in the upper and lower channel 46, 48 respectively. It will be noted from FIG. 6 that the coarse glass outlet 22 is adjacent and open to the lower end of the sieve screen 44, and the fine glass outlet 24 is adjacent and open to the lowermost portion of the housing floor 15.

The operation of the system is now described.

In operation, the fan 80 generates air streams flow along the upper and lower channels 46, 48, and the motors 20 cause the housing 12 to vibrate back and forth in a direction indicated by arrow V.

As co-mingled waste is dropped into the opening 14, the upper, coarse sieve screen 40 blocks the passage of all waste particles having dimensions greater than 30×20 mm. The waste caught on the sieve screen 40 is then urged by the vibrating motion of the housing 12 along the sieve screen 40 in a direction towards the first end 12a. On reaching the first end 12a, it falls from the first end 12a as indicated by the arrow F, is captured by the chute 32 and directed to a container (not shown) for further processing or disposal. The waste captured via the chute 32 comprises mainly unwanted, that is non-glass, material and potentially some oversized granules of glass.

Waste that does pass through the coarse sieve screen 40, falls, first, into the region 41 before passing through the barrier 42 into the upper channel 44. Within the upper channel 44, the waste interacts with the air stream with the result that materials lighter than glass and dust are largely entrained by the air stream and carried to the unwanted material outlet 26, thereby cleansing the remaining glass material. As the interaction takes place, the air stream is disrupted and turbulence tends to form which can lead to the agitation of dust and lighter material within the upper channel 44. In order to prevent the blow back of dust and lighter material upwards through the upper sieve screen 40 and out of the opening 14, which would obviously not be desirable, the passages 42b within the barrier 42 are blind to the direction of the air stream. This is achieved by arranging that each slat 42a points downwardly in a direction having a component parallel to the air stream which is in the direction of the air stream as best shown in detail C of FIG. 6. It will be noted that the slats 42a are all the same length so that none of the slats 42a stand proud of the others and the tips of the slats 42a occupy the same plane (in this case a plane inclined to the horizontal). As a result, the region 41 immediately under the barrier 42 is kept relatively free of agitated dust and lighter materials. Since the region 41 is relatively free of agitated dust and lighter materials, the region 41 has, in turn, less of a disrupting effect on the air stream in the upper channel 44 which leads to uniform classification at the second sieve screen 44 along the length of the upper channel.

The remaining waste, which comprises mainly granular waste glass is classified at the finer sieve screen 44. Waste glass blocked by the finer sieve screen 44, i.e. glass made of granules larger than 10×10 mm, is urged by the vibrating motion of the housing 12 in a direction along the screen 44 towards its lower end where it passes into the coarse glass outlet 22 for collection in a container (not shown) for recycling in new applications. A finer fraction of waste glass which passes through the sieve screen 44 enters the lower channel 46 where any remaining waste lighter than glass and dust is entrained by the air stream and carried to the unwanted material outlet 26. Meanwhile, the remaining waste, which comprises substantially only a finer fraction of glass (less than 10×10 mm granule size) accumulates on the housing floor 16. Again, the vibrating motion of housing urges the finer fraction of glass along the housing floor 16 to the finer glass outlet 24 for collection in a container (not shown) for recycling in new applications, such as, for example, as a filler in concrete.

Typically, the pressure of the air stream in the upper channel 46 is set, via adjustors 46a, 48a, to be approximately equal to the pressure of the air stream in the lower channel 48. However, for certain types of waste material, the pressure of the air stream in the upper channel 46 may be set to be higher than that in the lower channel 46. In this situation, the waste as it reaches the upper channel 46 having only undergone an initial coarse screening at the upper sieve screen 40 requires substantial cleansing in a high pressure stream. As the waste reaches the lower channel 48, however, it has undergone a finer screening at the lower sieve screen 44 and has already been cleansed by the air stream in the upper channel 46. For this reason, a lower pressure air stream in the lower channel 48 may suffice for certain types of waste material.

In other embodiments (not shown), below the second sieve screen 44, no air stream is supplied to the lower channel 46. Such an approach may be taken when, for example, the nature of the raw waste is such that a single step of cleansing the glass material in the upper channel 44 is considered sufficient.

In the illustrated embodiment, the upper and lower channels 46, 48 are shown as part of the same circuit with air being supplied from the fan 40 and lighter materials and dust being swept into the material separator 90. In other embodiments (not shown), this need not be the case, and for example, the upper and lower channels could be coupled to different further items of plant.

In the illustrated embodiment, the motors 20 generate the necessary vibrating motion to urge materials to the first end 12a of the housing 12 when they may be collected at the chute 32, at the course glass outlet 22, and at the fine glass outlet 24. In other embodiments (not shown), the housing 12 and the individual sieve screens 40, 44 could be vibrated independently.

1. A waste processing apparatus for separating a target material from other materials lighter than the target material and dust, and for classifying the target material into one or more fractions, comprising:
a housing having an opening for the input of waste, a first end and a second end;
a first sieve screen positioned under the opening and extending between the first and second ends;
a first channel, underneath the first sieve screen, for conveying a first air stream from a first channel inlet at the first end of the housing to a first channel outlet at the second end of the housing, the first air stream serving to entrain lighter materials and dust which have passed through the first sieve screen and transporting them to the first channel outlet; and
a vibrator operable to urge target material that has passed through the first sieve screen towards a first target material outlet at the first end of the housing;
wherein the apparatus further comprises a barrier, located between the first sieve screen and the first air stream, comprising a plurality of spaced slats, each slat pointing downwardly in a direction having a component parallel to the first air stream which is in the direction of the first air stream.

2. An apparatus as in claim 1, wherein the spacing between each slat is set such that material that has passed through the first sieve is just able to pass through the barrier.

3. An apparatus as in claim 1, wherein the tips of each slat occupy the same plane.

4. An apparatus as in claim 1, further comprising a second sieve screen, having a finer mesh than the first sieve screen, positioned below the first channel.

5. An apparatus as in claim 4, further comprising a second channel, underneath the second sieve screen, for conveying a second air stream from a second channel inlet at the first end of the housing to a second channel outlet at the second end of the housing, the second air stream serving to entrain lighter materials and dust which have passed through the second sieve screen and transporting them to the second channel outlet.

6. An apparatus as in claims 4, wherein the vibrator is further operable to urge target material that has passed through the second sieve towards a second target material outlet at the first end of the housing.

7. An apparatus as in claim 1, wherein said sieve is upwardly inclined in a direction from the first end to the second end of the housing.

8. An apparatus as in claim 7, further comprising a second sieve screen, having a finer mesh than the first sieve screen, positioned below the first channel, wherein the first target material outlet is disposed at the lowermost portion of the second sieve screen.

9. An apparatus as in claim 6, wherein the vibrator is further operable to urge target material that has passed through the second sieve towards a second target material outlet at the first end of the housing, and wherein the housing floor is inclined to the horizontal and the second target material outlet is open to material on the housing floor.

10. An apparatus as in claim 1, further comprising a chute adjacent to the first end of housing for collecting waste too large to pass through the first sieve screen.

11. An apparatus as in claim 1, adapted to process waste glass as the target material.

12. A system for processing waste comprising:
a waste processing apparatus for separating a target material from other materials lighter than the target material and dust, and for classifying the target material into one or more fractions, the waste processing apparatus comprising:
a housing having an opening for the input of waste, a first end and a second end;
a first sieve screen positioned under the opening and extending between the first and second ends;
a first channel, underneath the first sieve screen, for conveying a first air stream from a first channel inlet at the first end of the housing to a first channel outlet at the second end of the housing, the first air stream serving to entrain lighter materials and dust which have passed through the first sieve screen and transporting them to the first channel outlet; and
a vibrator operable to urge target material that has passed through the first sieve screen towards a first target material outlet at the first end of the housing;
wherein the apparatus further comprises a barrier, located between the first sieve screen and the first air stream, comprising a plurality of spaced slats, each slat pointing downwardly in a direction having a component parallel to the first air stream which is in the direction of the first air stream,
the system further comprising:
a blower for supplying said air stream to said channel and a material separator coupled to said channel outlet for processing other materials lighter than the target material and dust that are expelled from said channel.

13. A waste processing method for separating a target material from other materials lighter than the target material and dust, and for classifying the target material into one or more fractions, comprising:
providing a housing having an opening for the input of waste, a first end and a second end;
providing a first sieve screen positioned under the opening and extending between the first and second ends;
establishing a first air stream, underneath the first sieve screen, from the first end of the housing to a second end of the housing, the first air stream screening to entrain lighter materials and dust which have passed through the first sieve screen and transporting them from the housing;
providing a vibrator operable to urge target material that has passed through the first sieve towards a first target material outlet at the first end of the housing; and
providing a barrier, located between the first sieve screen and the first air stream, comprising a plurality of spaced slats, each slat pointing downwardly in a direction having a component parallel to the first air stream which is in the direction of the first air stream.
